(19) United States
(12) Patent Application Publication
(10) Pub. No.: US 2016/0162248 A1
(43) Pub. Date: Jun. 9, 2016

(54) Fish Finder Display System

(71) Applicant: Nathan Bassett, Milwaukee, WI (US)

(72) Inventor: Nathan Bassett, Milwaukee, WI (US)

(21) Appl. No.: 14/564,361

(22) Filed: Dec. 9, 2014

(51) Int. Cl. G06F 3/14; G02B 27/01; G01S 15/96

(52) U.S. Cl. CPC G06F 3/1454; G01S 15/96; G06F 3/1431; G02B 27/017; G02B 2027/0178

(57) ABSTRACT

A wireless fish finder display system is provided in which a visual output from a fish finder device is transmitted and displayed on a head mounted display unit. The wireless fish finder display system includes a pair of glasses having a receiver for receiving an output signal from the fish finder device and a display unit for displaying a visual output in a portion of the user's field of view while the user is fishing.

### FIELD OF THE INVENTION

The invention relates generally to fish finder display systems, and in particular, to a system adapted to transmit a visual output from a transducer of a fish finder device to a display unit mounted on the head of a user, which in turn, displays the visual output to the user while the user is fishing.

### BACKGROUND AND SUMMARY OF THE INVENTION

As is known to those skilled in the art, fish finding devices, such as sonar based fish finding devices, are capable of identifying the approximate location of fish within a body of water. Typical fish finders include an integrated or dashboard mounted display, such as an LCD or LED display. These displays provide a visual output for displaying information relative to the fish finding devices. Such information may include, water depth, fish location, fish depth, fish size, quantity of fish, etc.

However, such fish finding devices with traditional displays have various disadvantages. One common disadvantage of such a fish finding device is that the display is often fixed to the fishing boat or vessel. For example, in some fish finding devices the display may be attached to the housing of the fish finder device itself. In other devices, the display may be affixed to the vessel's dashboard or console by way of either a wired or wireless signal transmission. However, in both of these traditional displays, the user is required to look away from the water and temporarily stop fishing activities while viewing the fish finder display.

Therefore, it is a primary object and feature of the present invention to provide an fish finder display system that allows a user to view a visual output of a fish finder while simultaneously performing fishing related activities, such as casting and reeling.

It is a further object and feature of the present invention to provide a fish finder display system that may be mounted on the head of a user and displays a visual output of a fish finder to the user.

It is a further object and feature of the present invention to a fish finder display system that eliminates unnecessary movement while the user is in the process of viewing the fish finder display and simultaneously performing fishing activities.

It is a further object and feature of the present invention to a fish finder display system that increases the time a user can continuously access visual information from a fish finder display unit while performing fishing activities.

It is still a further object and feature of the present invention to provide a fish finder display system that is simple to use and inexpensive to manufacture.

In accordance with the present invention, a wireless fish finder display system is provided. The display system includes a fish finder configured to generate an output signal indicative of a fish location. A display apparatus is configured to be mounted on the head of a user and adapted to receive the output signal generated by the fish finder. A display screen is operatively connected to the display apparatus and configured to display a visual image indicative of the fish location in response to the output signal received by display apparatus.

The fish finder may include a transducer configured to generate the output signal and an adapter may be in electrical communication with the transducer.

A wireless transmitter may be electrical communication with the adapter. The transmitter is configured to wirelessly transmit the output signal to display apparatus. The display apparatus may take the form of a pair of glasses configured to be mounted on the head of a user. The pair of glasses includes first and second arms and first and second lenses disposed between the first and second arms. The first and second arms of the pair of glasses can be interchangeable relative to the location of the lenses and a wireless receiver may be located within one of the arms of the pair of glasses. The wireless receiver is configured to receive the output signal from the wireless transmitter. In addition, the display screen may be located within one of the arms of the pair of glasses. The display screen can take the form of a liquid crystal display (LCD) screen.

It is contemplated for the visual image indicative of the fish location to be projected from display screen onto a projection area on an inner surface of one of the first or second lenses. The projection area on the inner surface of one of the first or second lenses has a surface area less than a surface area of the corresponding first or second lens. The projection area may be located adjacent a distal edge of the corresponding first or second lens. The display screen may be a first display screen and the system may also include a second display screen. The second display screen has a surface area larger than a surface area of the first display screen. The adapter may be configured to modify the output signal in accordance with at least one parameter of the second display screen.

In accordance with a further aspect of the present invention, a wireless head mounted display devise is provided for use with a fish finder. The display devise includes at least one lens configured to be positioned adjacent an eye of a user and a projection area located on an inner surface of the at least one lens. A display screen is configured to project an image onto the projection area. The image is indicative of a location of a fish. A controller in electrical communication with the display screen provides the display screen with an image signal. A wireless receiver in electrical communication with the controller is configured to receive the image signal corresponding to an output signal generated by the fish finder.

The display device may also include a wireless transmitter operatively connectable the fish finder. The wireless transmitter transmits the image signal from the fish finder. An adaptor is operatively connected to the wireless transmitter and is configured to selectively modify the output signal from the fish finder and to provide the modified output signal as the image signal to the wireless transmitter. The display screen may be a first display screen and the display device may also include a second display screen. The second display screen includes a surface area larger than a surface area of the first display screen.

In accordance with a still further aspect of the present invention, a method of displaying a visual output of a fish finder to a user is provided. The method includes the steps of determining a fish location with the fish finder and mounting a display apparatus on the user. An output signal is wirelessly transmitted to the display apparatus from the fish finder. The output signal corresponds to the fish location. A display screen is operatively connected to the display apparatus and a visual image indicative of the fish location is displayed on the display screen in response to the output signal received by display apparatus.

The display apparatus may take the form of a pair of glasses configured to be mounted on the head of a user. The pair of glasses includes first and second arms and first and second lenses disposed between the first and second arms. A wireless receiver may be located within one of the arms of the pair of glasses. The wireless receiver is configured to receive the output signal from the fish finder. In addition, the display screen may be located within one of the arms of the pair of glasses. The method may also include the additional step of projecting the visual image indicative of the fish location from display screen onto a projection area on an inner surface of one of the first or second lenses.

These and other objects, advantages, and features of the invention will become apparent to those skilled in the art from the detailed description and the accompanying drawings. It should be understood, however, that the detailed description and accompanying drawings, while indicating preferred embodiments of the present invention are given by way of illustration and are not of limitation. Many changes and modifications may be made within the scope o the present invention without departing from the spirit thereof, and the invention includes all such modifications.

Consistent with the foregoing and in accordance with the invention as embodied and broadly described herein, a wireless fish finder display system is described in suitable detail to enable one of ordinary skill in the art to make and use the invention.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is a schematic drawing of a fish finder display system in accordance with the present invention;

FIG. 2 is a top plan view, partially in section, showing a head mounted display device for the fish finder display system of the present invention.

FIG. 3A is a side elevational view of a side of a first arm of the head mounted display device of FIG. 2.

FIG. 3B is a side elevational view of a view of a second arm of the head mounted display device of FIG. 2.

FIG. 4A and FIG. 4B are isometric views of the head mounted display device of FIG. 2 showing the interchanging of the first and second arms of the head mounted display device.

FIG. 5 is front elevational view of a fish finder display unit for use with the fish finder display system of the present invention.

FIG. 6 is a schematic diagram of a display adapter operatively connectable to a fish finder display unit for use with the fish finder display system of the present invention.

FIG. 7 is a schematic diagram of the fish finder display system of the present invention.

FIG. 8 is a schematic diagram of a display adapter and a head mounted display device of the fish finder display system of the present invention.

While describing the preferred embodiments of the invention, which are illustrated in the drawings, specific terminology will be resorted to for the sake of clarity. However, it is not intended that the invention be limited to the specific terms so selected ad it is understood that the each term includes all technical equivalents which operate in a similar manner to accomplish a similar purpose.

### DETAILED DESCRIPTION OF THE DRAWINGS

The present invention and the various features and advantageous details therefore are explained more fully with reference to the non-limited embodiments described in detail in the following description.

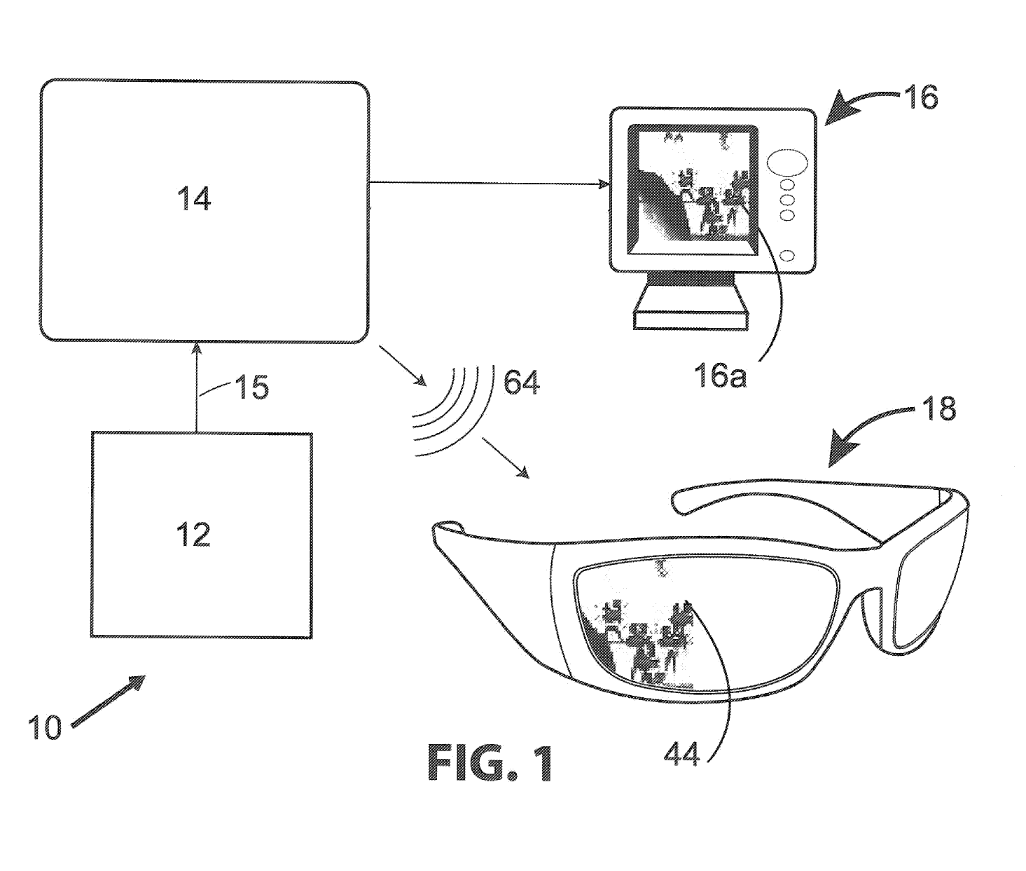

Referring initially to FIG. 1, a fish finder system in accordance with the present invention is generally designated by the reference numeral 10. The fish finder system 10 includes in-part a transducer 12. As is conventional, the transducer 12 of the fish finder system 10 includes a fish finder sensor (not shown) that generates a fish finder signal indicative of various information to be relayed to a user via fish finder display unit 16. It is intended for the information contained in the fish finder signal to be visually displayed on a display 16a of the fish finder display unit 16. By way of example, the fish finder signal generated by the transducer 12 may include information such as water depth, fish location, fish depth, fish size, quantity of fish, etc. It is contemplated for fish finder sensor to take the form of a sonar sensor, but other configurations are possible without deviating from the scope of the present invention.

In operation, the transducer 12 transmits the fish finder signal to a display adapter 14 via an electrical conductor 15. As hereinafter described, display adapter 14 is in electrical communication with a fish finder display unit 16 and is in wireless communication with head mounted display 18. As best seen in FIG. 1, the head mounted display 18 may take the form of a pair of glasses, however other visual display devices are considered well within the scope of this invention.

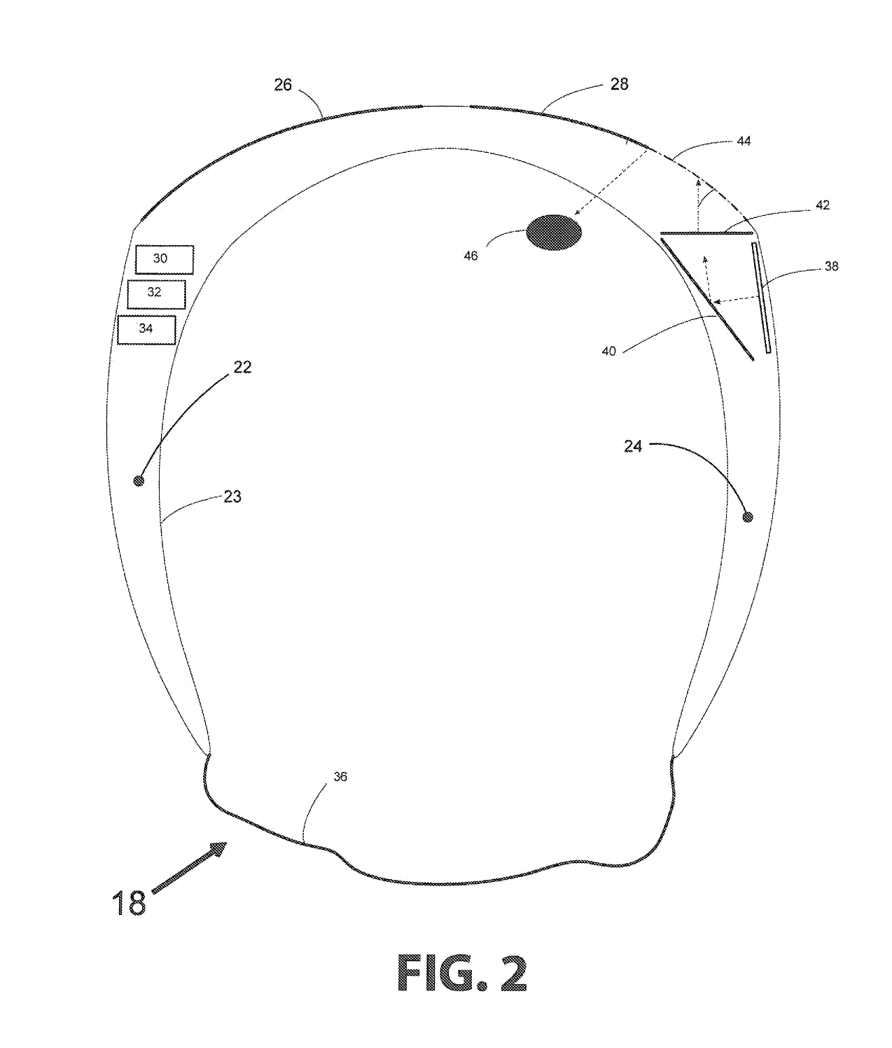

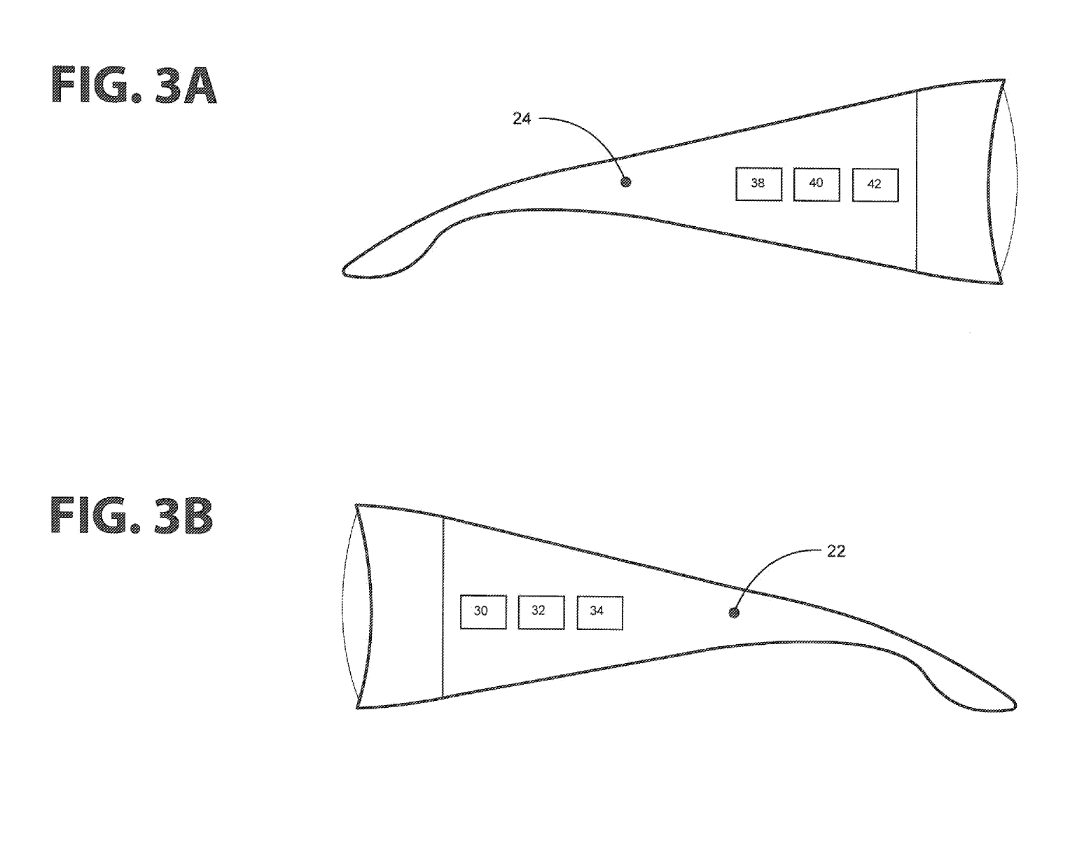

Referring to FIGS. 2-4B, it is contemplated for the head mounted display 18 to include a first arm 22, a second arm 24 and a pair of lenses 26, 28, in a traditional glasses form factor. The lenses 26, 28 may be polarized, tinted, colored, or offer UV protection to a user as to improve visibility while performing fishing actives. Further, as is conventional, first and second arms 22 and 24, respectively, are configured to be positioned on and supported by the ears of a user. In the depicted embodiment, the first arm 22 of the head mounted display 18 is designated the control arm and includes an outer housing 23 for receiving a power source 30, micro controller 32, and wireless receiver 34 therein. The power source 30, the micro controller 32, and the wireless receiver 34 are in electrical connection with each other. The power source 30 may take the form of a rechargeable or replaceable battery that supplies an electrical power to the various components of the head mounted display 18 herein described. A switch (not shown) may be operatively connected to the power source 30 for toggling the power source, and hence the power head mounted display 18, between an on and an off status.

The wireless receiver 34 of the first arm 22 is adapted to receive a processed fish finder signal from the display adapter 14, as hereinafter described. It is intended for the fish finder signal received by the wireless receiver 34 to be transmitted via electrical connection to the micro controller 32. As described in greater detail below, the micro controller 32 processes the output signal 20 and provides the processed output signal, hereinafter referred to as a display signal, to a display structure, generally designated by the reference numeral 33, housed within the second arm 24 via an electrical conductor, such as a cable or wire 36. As shown in FIG. 2, the wire 36 may extend between the opposing ends of the first and second arms 22 and 24, respectively, and act as a strap to prevent the head mounted display 18 from falling off of the user's head during operation. Alternatively, the wire 36 may be routed though the head mounted display 18, adjacent the first and second lenses 26 and 28, respectively. A schematic illustration of the transmission of the output signal 20 from the display adapter 14 to the head mounted display 18 is further depicted in FIG. 9.

Referring back to FIG. 2, in the depicted embodiment, the second arm 24 of the head mounted display 18 is designated the display arm. As heretofore described, the second arm 24 includes the display assembly 33 housed therein. Display assembly 33 is defined by an LCD display 38, a mirror 40, and projection lens 42. It is contemplated for the LCD display 38 to take the form of a micro display component that is adapted to receive the display signal transmitted by the micro controller 32 thereto via wire 36. In addition, the LCD display 38 received electrical power from a power supply 30 via an electrical connection, such as wire 36.

It is intended for the LCD display 38 to display a visual image to the user corresponding to the information gathered by the transducer 12, heretofore described. In order to align the visual image within the vision of the user, the LCD display positioned within the second arm 24 lies in a plane generally perpendicular to the inner surfaces 26a and 28a of display lenses 26 and 28, respectively. The visual image emitted from the LCD display 38 is directed towards and reflected off of a mirror 40. It is contemplated for the mirror 40 to be at an acute angle to the plane in which the LCD display lies, and preferably at an angle of approximately 45 degrees to the plane. The visual image emitted from the LCD display 38 reflected off of mirror 40 is directed towards and focused through a projection lens 42. It is intended for projection lens 42 to lie in a plane generally perpendicular to the plane in which the LCD display 38 lies. Resultantly, the visible image projected from the LCD display 38 is projected onto a projection area 44 located on the inner surface 28a of the adjacent lens 28. The projection area 44 is provided on the inner surface of 28a of lens 28 at a location corresponding to the peripheral portion of the user's field of view so as to allow the user's eye 46 to selectively view the projection area 44 when desired, and to provide an unobstructed view through the central portion and/or medial of the lenses 26 and 28 when performing fishing related activities. It is contemplated for the second arm 24, i.e. the display arm, to include one or more user interface devices, such as buttons, dials and/or switches located along the outer surface thereof which are operatively connected to the LCD display 38. It is intended for these such as buttons, dials or switches to be used by the user to alter various display options of the projected LCD image, in a conventional matter. For example, such display options may include brightness, contrast, color, focus, display mode, etc.

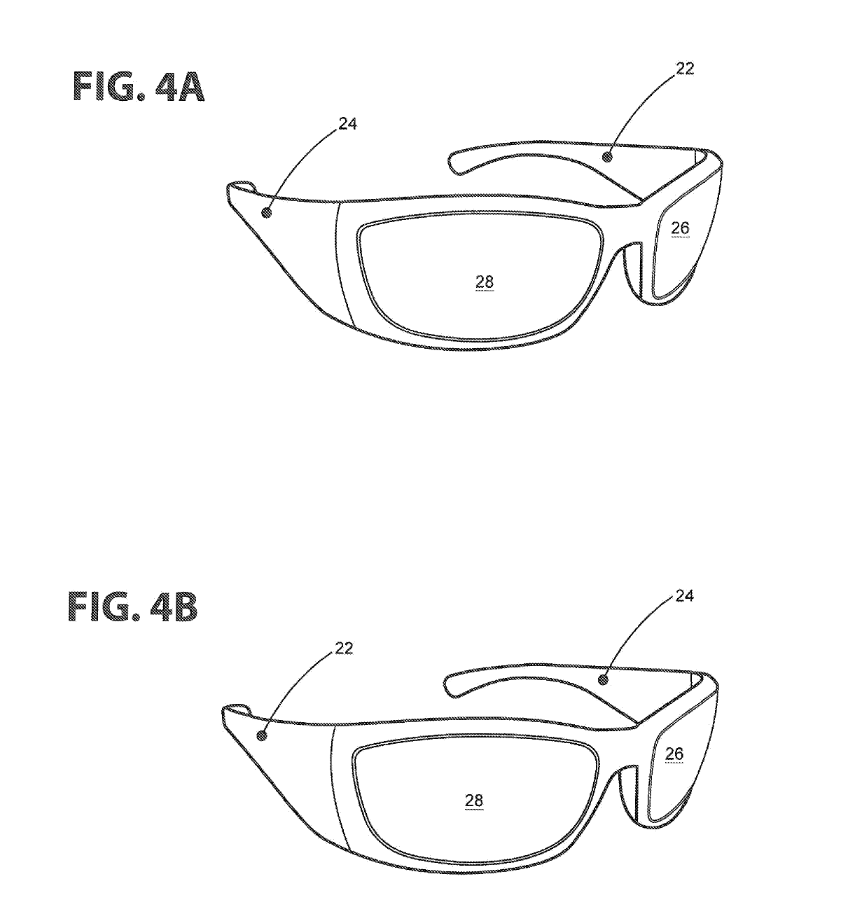

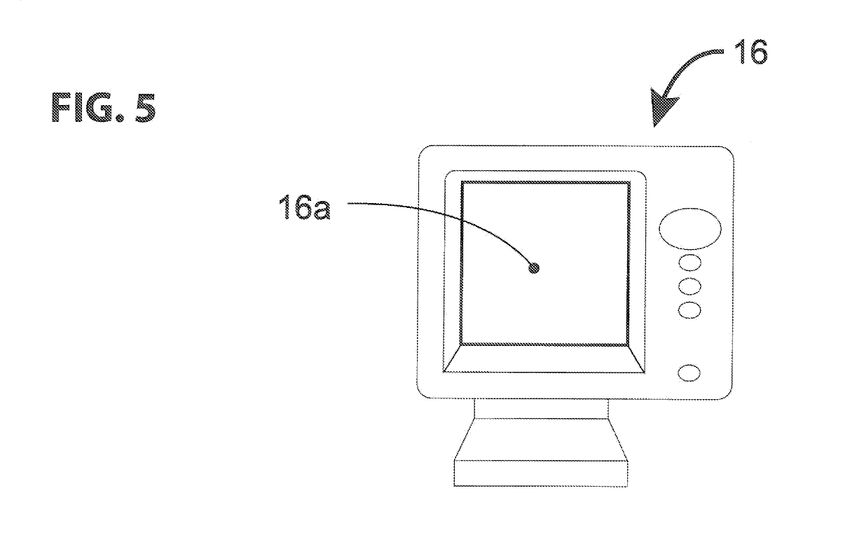

Referring to FIGS. 4A and 4B, it is contemplated for the first arm 22 and second arm 24 of the head mounted display 18 to be interchangeable. Accordingly, in the configuration shown in FIG. 4A, with the second arm 24, i.e. display arm, located on the right side of the head mounted display 18, the resultant projection area 44 will be located on lens 28, adjacent the user's right eye. Alternatively, in the configuration shown in FIG. 4B, with the second arm 24, i.e. display arm, located on the left side of the head mounted display 18, the resultant projection area 44 will be located on lens 26, adjacent the user's left eye. The ability to change the relative positions of the first and second arms 22 and 24, respectively, allows the user to adjust the projection area 44 to the most comfortable viewing location or to accommodate users with either right eye or left eye dominance.

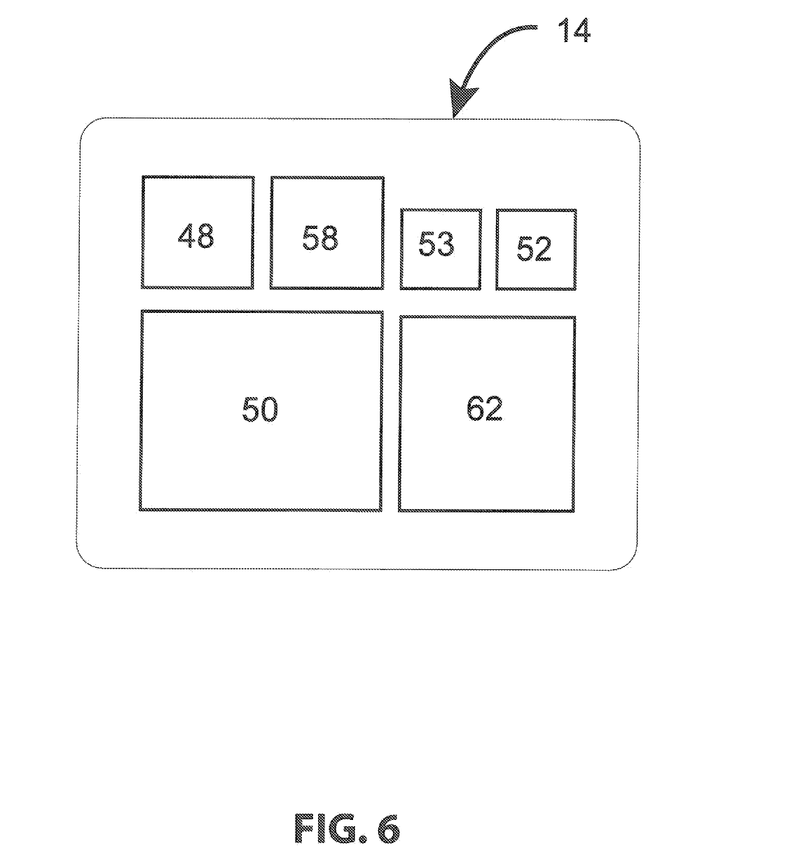

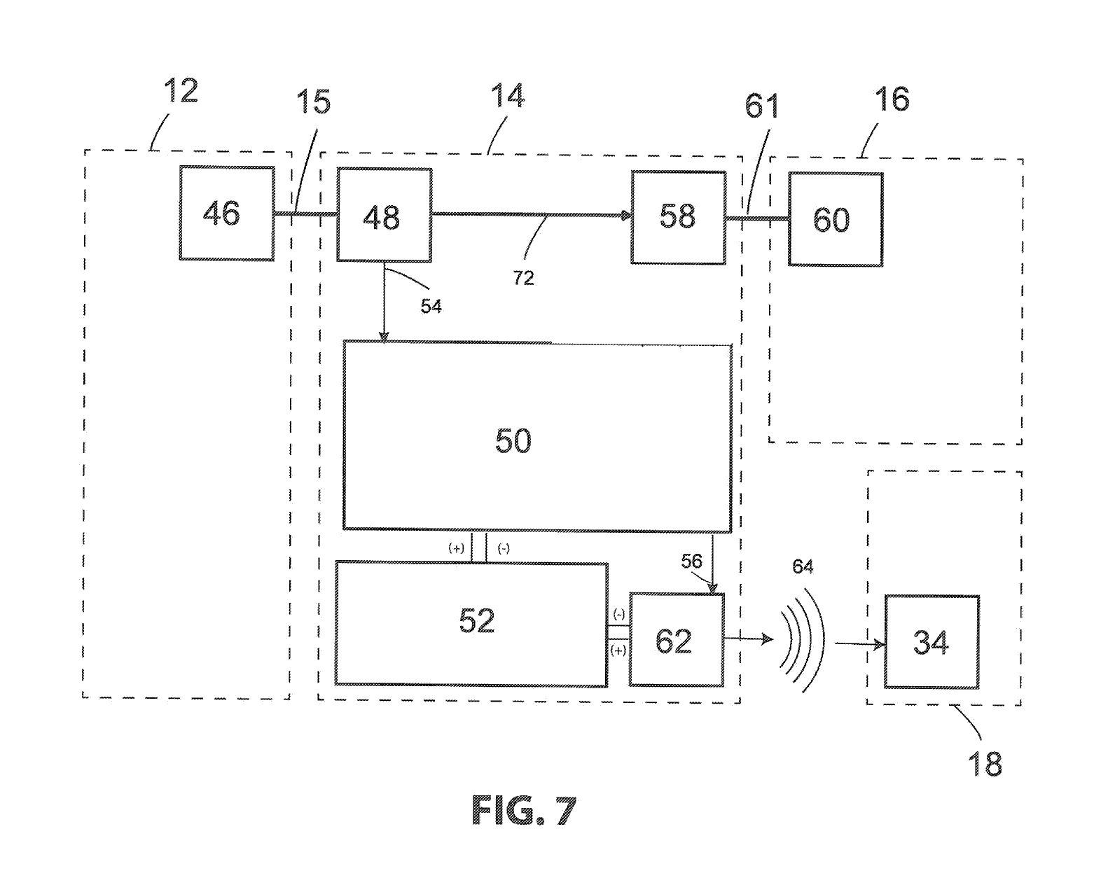

Referring to FIG. 7, as heretofore described, the transducer 12 of the fish finder system 10 generates a fish finder signal (not shown) from the fish finder sensor. An output 46 within the transducer 12 transmits the fish finder signal along the electrical conductor 15 to an input 48 located within the display adaptor 14. The fish finder signal is provided to the central processor 50 of display adapter 14 via line 54. Display adapter 14 includes a power source 52 operatively connected to central processor 50 to supply electrical power thereto. The power source 52 may take the form of a rechargeable or a replaceable battery. A switch 53, as is shown in FIG. 6, may be operatively connected to the power source 52 for toggling the power supply to the central processor 50 of the display adapter 14, between an “on” and an “off” status. When the user has selected to display the fish finder signal on the head mounted display 18, switch 53 is toggled to the “on” position which provides power to the central processor 50. In this configuration it is intended for the central processor 50 to convert the incoming fish finder signal received on line 54 to a processed fish finder signal, which is then transmitted to the head mounted display unit 18, via line 56 and wireless transmitter 62, as discussed in further detail below.

If the user desires to display the information contained in the fish finder signal on fish finder display unit 16 without utilizing the head mounted display 18, the central processor 50 may be bypassed by toggling switch 53 to the “off” position and thereby interrupting power to the central processor 50. In this configuration, transmitter 58 receives the fish finder signal directly from the input 48 via line 72 and transmits the fish finder signal to the input 60 of fish finder display unit 16 via line 61.

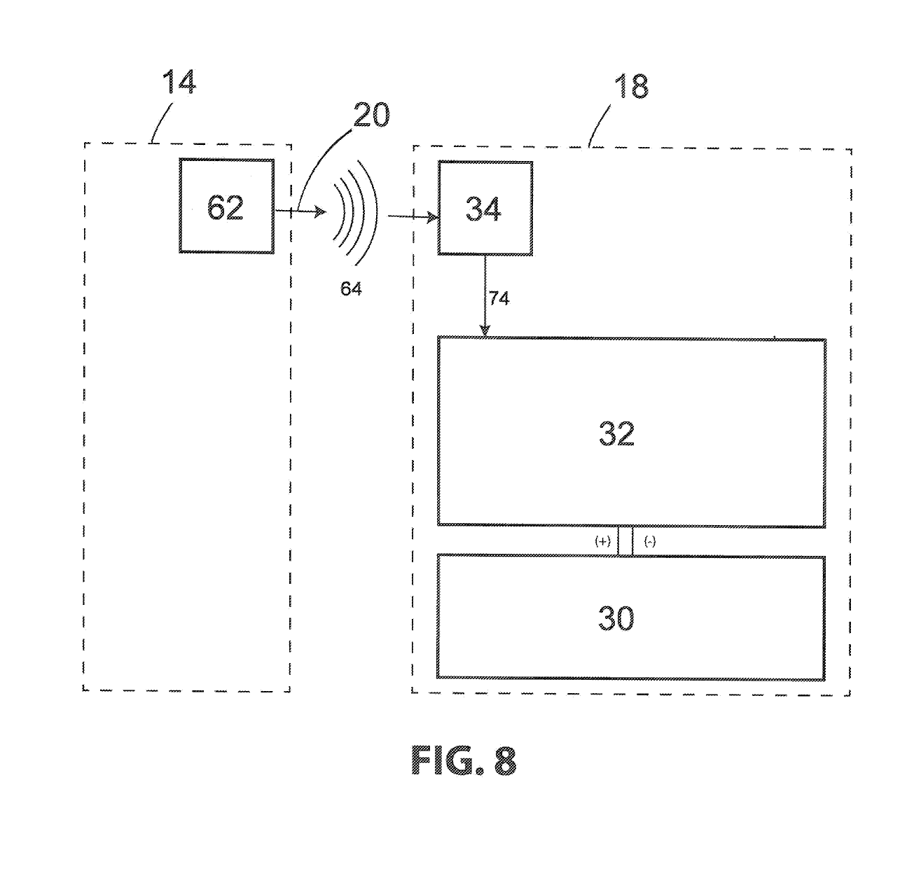

As previously indicated, if the user desires to display the information contained in the fish finder signal on the head mounted display unit 18, wireless transmitter 62 receives the fish finder signal from the central processer 50 via line 56 and transmits the fish finder signal to the wireless receiver 34 of head mounted display unit 18 via, wireless link 64. Referring to FIG. 8, in more detail, the receiver 34 of the head mounted display unit 18 receives the fish finder signal via wireless link 64 and transmits that signal to the micro controller 32 via line 74, such that digital rendering of the fish finder signal may be generated in the head mounted display unit 18.

In an alternative embodiment, a switch located at input 48 may receive the incoming fish finder signal from line 15 and be configured to operatively connect to either or both the central processor 50 via line 54 and the transmitter 58 via line 72. By toggling the switch at input 48, the output location of the fish finder signal may be selected from: the central processor 50 when use of the head mounted display unit 18 desired; the transmitter 58 when use of the fish finder display unit 16 is desired; or both the central processor 50 and the transmitter 58 when use of both the head mounted display unit 18 and the fish tinder display unit 116 is desired. In this embodiment, the fish finder signal transmission path within the display adapter 14 may be altered without toggling the power supply to the central processor 50 between an “on” and an “off” status.

The above embodiments are provided as way of example and the present invention is not limited thereto. Various additions, modifications and rearrangement of the feature of the present invention may be made without deviating from the scope of this invention. Moreover, the individual components and features of each disclosed embodiment can be combines with or substituted for the disclosed features of every other disclosed embodiment exempt where such features are mutually exclusive.

I claim:

1. A wireless fish finder display system, comprising:
a fish finder configured to generate an output signal indicative of a fish location;
a display apparatus configured to be mounted on the head or a user and adapted to receive the output signal generated by the fish finder; and
a display screen operatively connected to the display apparatus and configured to display a visual image indicative of the fish location in response to the output signal received by display apparatus.

2. The system of claim 1 wherein the fish finder includes a transducer configured to generate the output signal.

3. The system of claim 2 further comprising an adapter in electrical communication with the transducer, the adapter configured to modify the output signal in accordance with at least one parameter of the display screen.

4. The system of claim 3 wherein the parameter of the display screen is the height of the display screen.

5. The system of claim 3 wherein the parameter of the display screen is the width of the display screen.

6. The system of claim 3 further comprising a wireless transmitter in electrical communication with the adapter, the transmitter configured to wirelessly transmit the output signal to display apparatus.

7. The system of claim 6 wherein the display apparatus is a pair of glasses configured to be mounted on the head of a user, the pair of glasses including first and second arms and first and second lenses disposed between the first and second arms.

8. The system of claim 7 wherein the first and second arms of the pair of glasses are interchangeable relative to the location of the lenses.

9. The system of claim 7 further comprising a wireless receiver located within one of the arms of the pair of glasses, the wireless receiver configured to receive the output signal from the wireless transmitter.

10. The system of claim 7 wherein the display screen is located within one of the arms of the pair of glasses.

11. The system of claim 10 wherein the display screen is a liquid crystal display (LCD) screen.

12. The system of claim 9 wherein the visual image indicative of the fish location is projected from display screen onto a projection area on an inner surface of one of the first or second lenses.

13. The system of claim 12 wherein the projection area on the inner surface of one of the first or second lenses has a surface area less than a surface area of the corresponding first or second lens.

14. The system of claim 12 wherein the projection area is located adjacent a distal edge of the corresponding first or second lens.

15. The system of claim 3 wherein the display screen is a first display screen and wherein the system further comprises a second display screen, the second display screen including a surface area larger than a surface area of the first display screen.

16. The system of claim 15 wherein the adapter is configured to modify the output signal in accordance with at least one parameter of the second display screen.

17. A wireless head mounted display devise for use with a fish finder, the display devise comprising:
at least one lens configured to be positioned adjacent an eye of a user;
a projection area located on an inner surface of the at least one lens;
a display screen configured to project an image onto the projection area, wherein the image is indicative of a location of a fish;
a controller in electrical communication with the display screen, the controller providing the display screen with an image signal; and
a wireless receiver in electrical communication with the controller, the wireless receiver configured to receive the image signal corresponding to an output signal generated by the fish finder.

18. The display device of claim 17 further comprising a wireless transmitter operatively connectable the fish finder, the wireless transmitter transmitting the image signal from the fish finder.

19. The display device of claim 18 further comprising an adaptor operatively connected to the wireless transmitter and being configured to selectively modify the output signal from the fish finder and to provide the modified output signal as the image signal to the wireless transmitter.

20. The display device of claim 17 wherein the display screen is a first display screen and wherein the display device further comprises a second display screen, the second display screen including a surface area larger than a surface area of the first display screen.

21. A method of displaying a visual output of a fish finder to a user, comprising the steps of:
determining a fish location with the fish finder;
mounting a display apparatus on the user;
wirelessly transmitting an output signal to the display apparatus from the fish finder, the output signal corresponding to the fish location;
operatively connecting a display screen to the display apparatus; and
displaying on the display screen a visual image indicative of the fish location in response to the output signal received by display apparatus.

22. The method of claim 21 wherein the display apparatus is a pair of glasses configured to be mounted on the head of a user, the pair of glasses including first and second arms and first and second lenses disposed between the first and second arms.

23. The system of claim 22 further comprising a wireless receiver located within one of the arms of the pair of glasses, the wireless receiver configured to receive the output signal from the fish finder.

24. The system of claim 22 wherein the display screen is located within one of the arms of the pair of glasses.

25. The system of claim 24 comprising the additional step of projecting the visual image indicative of the fish location from display screen onto a projection area on an inner surface of one of the first or second lenses.
